(19) United States
(12) Patent Application Publication
(10) Pub. No.: US 2013/0162820 A1
(43) Pub. Date: Jun. 27, 2013

(54) STREET LIGHT HAVING ALARM DEVICE AND ALARM METHOD

(71) Applicants: CHIH-SAN CHIANG, Tu-Cheng (TW); HAN-CHE WANG, Tu-Cheng (TW); HUA-DONG CHENG, Shenzhen City (CN); LI-ZHANG HUANG, Tu-Cheng (TW)

(72) Inventors: CHIH-SAN CHIANG, Tu-Cheng (TW); HAN-CHE WANG, Tu-Cheng (TW); HUA-DONG CHENG, Shenzhen City (CN); LI-ZHANG HUANG, Tu-Cheng (TW)

(73) Assignees: HON HAI PRECISION INDUSTRY CO., LTD., Tu-Cheng, New Taipei (TW); HONG FU JIN PRECISION INDUSTRY (ShnZhen) CO., LTD., Shenzhen City (CN)

(21) Appl. No.: 13/534,262

(22) Filed: Jun. 27, 2012

(30) Foreign Application Priority Data
Dec. 24, 2011 (CN) 201110438372.9

(51) Int. Cl. H04N 7/18

(52) U.S. Cl. 348/143; 348/E07.087

(57) ABSTRACT

A street light includes a post, a light source mounted on the post, a communicating unit, a button unit, a camera unit, a storage unit, and a central control unit. The communicating unit communicates with a server which includes an alarm system. The button unit and the camera unit are mounted on the post. The central control unit enables the camera unit to take photo of an area adjacent to the street light in response to manual operation of the button unit. The storage unit stores location information of the street light and the photos taken by the camera unit. The central control unit further transmits the photo and the location information obtained from the storage unit to the server via the communication unit. A related method is also provided.

### BACKGROUND

1. Technical Field

The present disclosure relates to alarm devices and alarm methods, and particularly, to a street light having an alarm device and alarm method applied in the alarm device.

2. Description of the Related Art

When accident/emergency occurs, people usually call the police or other related people depending on the type of emergency. However, people may not know the exact location of the accident/emergency. Therefore, there is room for improvement in the art.

### BRIEF DESCRIPTION OF THE DRAWINGS

The components in the drawing are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an alarm system in accordance with an exemplary embodiment.

FIG. 2 is a flow diagram that describes steps of a method in accordance with an exemplary embodiment.

### DETAILED DESCRIPTION

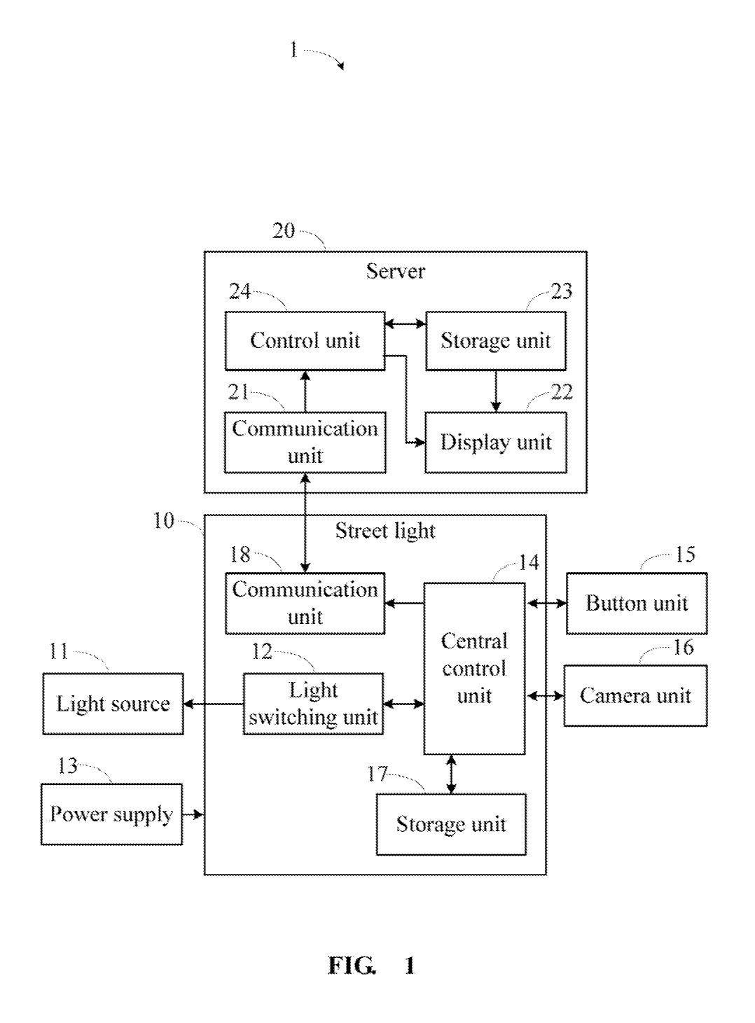

FIG. 1 is a block diagram of an alarm system in accordance with an exemplary embodiment. The alarm system 1 includes an alarm device applied in a street light 10 and a server 20 communicating with the street light 10 via a network (not shown). In the embodiment, the server 20 is a server of the traffic accident management center.

The street light 10 includes a light source 11, a light switching unit 12, and a power supply 13. The light source 11 is mounted on a post (not shown) for illumination. In the embodiment, the power supply 13 is a solar power supply. However the power supply may be other types of power sources in other embodiment.

The street light 10 further includes a central control unit 14, a button unit 15, a camera unit 16, a storage unit 17, and a communication unit 18. The storage unit 17 stores the location information of the street light 10. The location information includes geographical location, such as longitude and latitude or street location, of the street light 10.

The button unit 15 is mounted on the post of the street light 10 for a user to operate manually. The light switching unit 12 is connected between the light source 11 and the power supply 13, and turns on/off the light source 11 in response to manual operation of the button unit 15. The camera unit 16 mounted on post of the street light 10 takes photos of an area adjacent to the post. The storage unit 17 further stores the photos taken by the camera unit 16. The communication unit 18 communicates with the server 20 via the network, such as Internet, virtual private network (VPN), or WiFi.

When an accident or emergency occurs, users operate the button unit 15, and the central control unit 14 enables the camera unit 16 to take the photos of an area adjacent to the post for a predetermined time in response to manual operation of the button unit 15. The central control unit 14 further stores the photos taken by the camera unit 16 in the storage unit 17. Meanwhile, the central control unit 14 obtains the location information of the street light 10 from the storage unit 17, and transmits the photos and the location information to the server 20 via the communication unit 18.

The server 20 includes a communication unit 21, a display unit 22, a storage unit 23, and a control unit 24. The communication unit 21 communicates with the communication unit 18 of the street light 10, to receive photos and location information from the street light 10 when an accident or emergency occurs around the street light 10. In the embodiment, when photos and location information is received from the street light 10 via the communication unit 21, the control unit 24 stores the photos and the location information in the storage unit 23. Meanwhile, the control unit 24 automatically displays the photos and the location information on the display unit 22. That is, upon receiving information from the street light 10, the server 20 automatically displays the information without any human intervention, this helps the people viewing the display unit 22 to know in a timely manner that an accident or emergency has occurred around the street light 10 and give help to those involved in the accident/emergency immediately.

In the embodiment, after the camera unit 16 finishes taking photos, the central control unit 14 controls the light source 11 to enter a signaling mode by utilizing the light switching unit 12. The signaling mode is distinct from the normal mode or modes of the light source 11. The light-emitting unit 11 generally has a normal “off” mode during the daytime and a normal “on” mode emitting a particular color (e.g., white), during the nighttime. Therefore, the signaling mode is distinct from the normal “on” mode and the normal “off” mode, for example, the signaling mode could be a red light flashing at a predetermined frequency. In the embodiment, the controlling of the light source 11 to enter the signaling mode is to attract people nearby and guide people to the site of the accident or emergency.

In an alternative embodiment, the street light 10 includes two light sources 11. One of the two light sources 11 is used for illumination, and the other one is for flashing when the accident/emergency occurs.

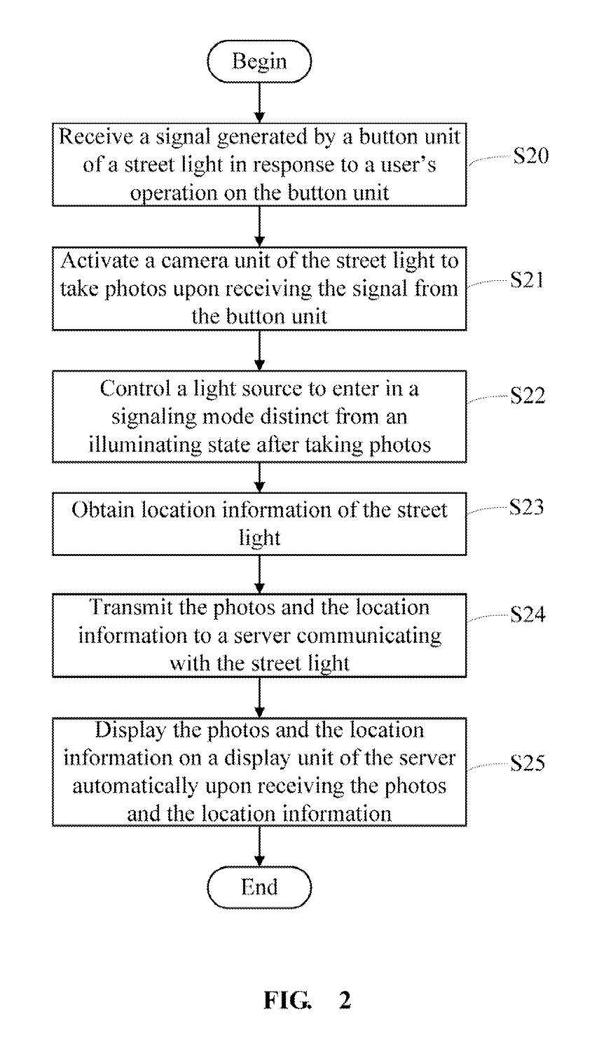

FIG. 2 is a flow diagram that describes steps of a method in accordance with an exemplary embodiment.

In step S20, the street light 10 receives a signal generated by the button unit 15 in response to a user's operation on the button unit 15.

In step S21, the central control unit 14 activates the camera unit 16 to take photos of the area adjacent to the street light 10 for a predetermined time in response to the signal generated by the button unit 15.

In step S22, the central control unit 14 controls the light source 11 to enter in a signaling mode distinct from the illuminating state by utilizing the light switching unit 12.

In step S23, the central control unit 14 stores the photos taken by the camera unit 16 in the storage unit 17. Meanwhile, the central control unit 14 obtains the location information of the street light 10 from the storage unit 17.

In step S24, the central control unit 14 transmits the photos and the location information to the server 20 by the communication unit 18.

In step S25, the control unit 24 stores the photos and the location information in the storage unit 23. Meanwhile, the control unit 24 automatically displays the photos and the location information on the display unit 22.

The signaling mode is distinct from the normal mode or modes of the light source 11. The light source 11 generally has a normal “off” mode during the daytime and a normal “on” mode emitting a particular color (e.g., white), during the nighttime. Therefore, the signaling mode is distinct from the normal “on” mode and the normal “off” mode, For example, the signaling mode is a red light flashing at a predetermined frequency. In the embodiment, the controlling of the light source 11 to enter the signaling mode is to attract people nearby and guide people to the site of the accident or emergency.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A street light comprising:
a post;
a light source mounted on the post;
a communicating unit configured to communicate with a server which comprises an alarm system;
a button unit mounted on the post for a user to operate manually;
a camera unit mounted on the post and configured to take photos of an area adjacent to the post;
a storage unit configured to store location information of the post and the photos taken by the camera unit; and
a central control unit configured to enable the camera unit to take the photos in response to manual operation of the button unit, and transmits the photos and the location information obtained from the storage unit to the server via the communication unit.

2. The street light as recited in claim 1, wherein the light source is operable in an illuminating state under which the light source emits light for illumination.

3. The street light as recited in claim 2, wherein the central control unit is configured to control the light source enter a signaling mode after the camera unit finishes taking the photos.

4. The street light as recited in claim 3, wherein under the signaling mode the light source flickers at a predetermined frequency.

5. The street light as recited in claim 4, wherein under the signaling mode the light source emits red light.

6. A method for alarming applied in a street light comprising an alarm device, the alarm device comprising a communication unit configured to communicate with a server, wherein the method comprising:
receiving a signal generated by a button unit in response to a user's operation on the button unit;
activating a camera unit of the street light to take photos upon receiving the signal from the button unit;
obtaining location information of the street light; and
transmitting the photos and the location information to the server by the communication unit to display the photos and the location information on a display of the server automatically.

7. The method as recited in claim 6, wherein the street light includes a light source operable in an illuminating state under which the light source emits light for illumination.

8. The method as recited in claim 7, further comprising:
controlling the light source to enter in a signaling mode distinct from the illuminating state after taking photos.

9. The method as recited in claim 8, wherein under the signaling mode the light source flickers at a predetermined frequency.

10. The method as recited in claim 9, wherein under the signaling mode the light source emits red light.
